(19) United States
(12) Patent Application Publication
(10) Pub. No.: US 2018/0346060 A1
(43) Pub. Date: Dec. 6, 2018

(54) Human Powered Flywheel Drive System

(71) Applicant: Zane Cousins Hunker, San Diego, CA (US)

(72) Inventor: Zane Cousins Hunker, San Diego, CA (US)

(73) Assignee: Zane Cousins Hunker

(21) Appl. No.: 15/821,136

(22) Filed: Nov. 22, 2017

Related U.S. Application Data
(60) Provisional application No. 62/435,673, filed on Dec. 16, 2016.

(51) Int. Cl. B62M 1/10; F16F 15/30; F03G 3/08; F16D 43/04; B62M 1/30

(52) U.S. Cl. CPC B62M 1/10; F16F 15/30; B62M 1/30; F16D 43/04; F03G 3/08

(57) ABSTRACT

The “HUMAN POWERED FLYWHEEL DRIVE SYSTEM” is a vehicle drive system utilizing a flywheel positioned concentrically within an air sealed space inside a drive wheel, so as to rotate in a coaxial configuration with both the drive wheel and flywheel rotating independently until the drive wheel is propelled to between a ten and fifteen mile per hour speed, when the rotation of the drive wheel is coupled to that of the flywheel so as to purpose stored energy for added momentum and torque. Braking is applied only to the drive wheel while allowing the flywheel to remain spinning freely to store energy.

### CROSS REFERENCE TO RELATED APPLICATION

### US Patent Documents

U.S. Pat. No. 633,417 Frederick E. B. Beaumont . . . Sep. 19, 1899

U.S. Pat. No. 1,926,483 Stone J. & Co . . . Sep. 12, 1933

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### STATEMENT REGARDING PRIOR DISCLOSURES BY THE INVENTOR OR A JOINT INVENTOR

Not Applicable

### INCORPORATION-BY-REFERENCE OF MATERIAL SUBMITTED ON A COMPACT DISC OR AS A TEXT FILE VIA THE OFFICE OF ELECTRONIC FILING SYSTEM (EFS-WEB)

Not Applicable

### BACKGROUND OF THE INVENTION

Every scooter, bicycle and other small land vehicle ever produced thus far has derived propulsion from one or two of the following sources that include the rider kicking the ground, pedaling, or a fuel as in electricity or gasoline. Individuals become tired and fatigued after sustained kicking or pedaling. Electric power requires a motor and a battery as well as lengthy charging times and electrical infrastructure. Gasoline power requires an engine, a fuel tank and refueling, while causing noise and co2 emissions. A flywheel offers similar sustained propulsion to that of electricity or gasoline without the need for motors, batteries, engines, fuel tanks, recharging or refueling while causing no noise and no Co2 emissions.

### FIELD OF INVENTION

The present invention relates to a vehicle drive system.

### DESCRIPTION OF RELATED ART INCLUDING DISCLOSED UNDER 37 CFR 1.97 AND 1.98

Not Applicable

### BRIEF SUMMARY OF THE INVENTION

A weighted flywheel is positioned concentrically within an air sealed space inside a drive wheel allowing both the flywheel and drive wheel to rotate independently as they are attached respectively, to the inner and outer shafts of the coaxial shaft pairing one of two, with said drive wheel being attached to the coaxial shaft pair one outer shaft by means of the hollow wheel spoke structure surrounding and containing the flywheel within an air sealed space. Each of the coaxial shaft pairs contain an outer and an inner shaft. Described starting forward and moving aft in order as a linear arrangement of three include the accelerator shaft, coaxial shaft pairing two and coaxial shaft pairing one, all of which extend outward from a single side of the horizontally positioned wheel fork in order to anchor and couple the gears contained within a safety housing. A reciprocating foot accelerator pedal turns a ratchet gear mechanism at its base surrounding the accelerator shaft thereby transforming reciprocating power into rotational power by rotating an expansion gear that turns a drive chain which also loops around a smaller reduction gear located on the outer end of the coaxial shaft pairing two inner shaft thereby driving the gears and shaft that turn the drive wheel consistently while the coaxial shaft pairing two outer shaft is attached to a centrifugal clutch which is contained within the drive gearing for the flywheel allowing the faster rotation of the flywheel to be coupled to the slower rotation of the drive wheel once the vehicle is propelled to a speed between ten and fifteen miles per hour. Attached at the end of the coaxial shaft pair one inner shaft and located directly on the opposite side of the vehicle to all of the gearing set inside the safety housing is a reciprocating foot starter pedal which drives a ratchet gear mechanism rotating said coaxial shaft pair one inner shaft as that shaft is attached to and through the flywheel.

To properly operate the invention from a standstill the rider must first step down a couple times on a reciprocating foot starter pedal from a stationary standing position beside the vehicle before boarding while holding the vehicle in place by keeping at least one hand on the vehicle's handlebars. This action only begins the rotation of the flywheel from a standstill and becomes unnecessary once the flywheel is spinning. Once the rider boards the vehicle with both hands on the handlebars they step down with either their left or right foot onto a reciprocating accelerator pedal located directly behind the rider's standing position that engages gearing which propels the vehicle forward and couples the rotation of the drive wheel to the flywheel once the vehicle reaches a speed between ten and fifteen miles per hour via a centrifugal clutch. The coupling of the faster rotating flywheel to the slower rotating drive wheel when both are propelled by the accelerator pedal provides consistent momentum and torque. When braking is applied the slowing of the drive wheel automatically disengages the centrifugal clutch thereby allowing the flywheel to continue to spin freely to conserve energy for use again once the rider brings the vehicle back to a speed between ten and fifteen miles per hour.

With comparable effort to that of accelerating a pedal powered bicycle from a standstill to a steady speed, the rider of a vehicle incorporating the HUMAN POWERED FLYWHEEL DRIVE SYSTEM can enjoy similar sustained torque to a comparably sized electric powered vehicle through means of the kinetic energy storage capacity of the flywheel as it is spinning.

Alternately as opposed to a reciprocating foot accelerator pedal, power input for the invention may be derived from a foot pedal driven chain, or from a motor or engine applied to the invention in a hybrid power role.

### BRIEF DESCRIPTION OF SEVERAL VIEWS OF THE DRAWINGS

FIG. 1a is a rear quarter perspective view showing the accelerator pedal and gears.

FIG. 1b is a side perspective view as included in the application of the invention.

FIG. 2a is a rear view showing the exact placement of the flywheel within the drive wheel.

FIG. 2b is a rear view as included in the application of the invention.

FIG. 3a is a rear quarter view showing the starter pedal and brake.

FIG. 3b is a side view as included in the application of the invention.

FIG. 4a is a top down view showing the complete sequence of gears and pedal inputs.

FIG. 4b is a top down view as included in the application of the invention.

FIG. 5 is a top down view showing the complete sequence and rotation of gears and coaxial shafts.

### DETAILED DESCRIPTION OF THE INVENTION

With comparable effort to that of accelerating a pedal powered bicycle from a standstill to a steady speed, the rider of a small vehicle incorporating the HUMAN POWERED FLYWHEEL DRIVE SYSTEM can enjoy similar sustained speed and higher torque to that provided by an electric motor through means of the kinetic energy storage capacity of the flywheel as it is spinning. Power for the invention may be derived from a foot pedal driven chain, reciprocating foot pedal driven ratchet gear mechanism, or from an electric or gas powered motor applied in a hybrid role with the invention.

The present invention comprises of a Drive Wheel 10 Flywheel 12 Drive Wheel Spoke Structure 14 Coaxial Shaft Pairing One Outer Shaft 16 Coaxial Shaft Pairing One Timer Shaft 18 Drive Wheel Hub Gear 20 Flywheel Hub Gear 22 Brake 24 Drive Wheel Drive Gear 26 The Flywheel Drive Gear 28 Centrifugal Clutch 30 Drive Chain 32 Starter Pedal 34 Coaxial Shaft Pairing Two Outer Shaft 36 Coaxial Shaft Pairing Two Timer Shaft 38 Accelerator Pedal 40 Drive Wheel Fork 42 Drive Wheel Ratchet Gear Hub 44 Flywheel Ratchet Gear Hub 46 Drive Wheel Tensioner 48 Flywheel Tensioner 50 Accelerator Shaft 52 Expansion Gear 54 Reduction Gear 56 Safety Housing 58

The Drive Wheel 10 is the steel frame and rubber tire rear driving wheel of the vehicle to which the invention is applied. The Flywheel 12 is a rotating steel disc contained inside the Drive Wheel within the inner dimensions of the steel and transparent plastic Drive Wheel Spoke Structure 14. The Coaxial Shaft Pairing One Outer Shaft 16 surrounds the Coaxial Shaft Pairing One Inner Shaft 18 as they together form the first of two steel coaxial shaft pairs contained within the invention. The Drive Wheel Hub Gear 20 is a steel gear connected by the Coaxial Shaft Pairing One Outer Shaft 16 to the Drive Wheel 10. The Flywheel Hub Gear 22 is a steel gear connected by the Coaxial Shaft Pairing One Inner Shaft 18 to the Flywheel 12. The Brake 24 extends each side of its steel calipers longitudinally to clasp either side of the drive wheel 10 from its placement aft of the standing position of the rider. The Drive Wheel Drive Gear 26 is a steel gear connected to the Coaxial Shaft Pairing Two Inner Shaft 38. The Flywheel Drive Gear 28 is a steel gear that concentrically surrounds the Centrifugal Clutch 30 allowing both to rotate as collectively at their shared center point to the Coaxial Shaft Pairing Two Outer Shaft 36. The Drive Chain 32 is steel drive chain that transmits power from the Expansion Gear 54 to the Reduction Gear 56. The Starter Pedal 34 is a steel reciprocating foot pedal connected to the Flywheel Ratchet Gear Hub 46. Coaxial Shaft Pairing Two Outer Shaft 36 surrounds Coaxial Shaft Pairing Two Inner Shaft 38 as they together form the second of two steel coaxial shaft pairs contained within the invention. The Accelerator Pedal 40 is a steel reciprocating foot pedal connected to the Drive Wheel Ratchet Gear Hub 44 and extends upward through an opening in the Safety Housing 58 to cantilever over the Drive Wheel 10. The Drive Wheel Fork 42 is a steel frame which extends its two protruding members from a their merged anchor point aft of the standing position of the rider to then anchor the left and right hubs of the Drive Wheel 10 as well as to anchor all other parts of the invention. The Drive Wheel Ratchet Gear Hub 44 is a steel ratchet gear mechanism mounted on the Accelerator Shaft 52 that anchors the Accelerator Pedal 40 to its vertically pivoting position. The Flywheel Ratchet Gear Hub 46 is a steel ratchet gear mechanism connected to the Coaxial Shaft Pairing Two Inner Shaft 38. The Drive Wheel Tensioner 48 is a steel spring mechanism that adds recoil to the Flywheel Tensioner 50 is a steel spring mechanism that adds recoil to the Starter Pedal 34. The Accelerator Shaft 52 extends outward and perpendicular from the frame through the center point of the Drive Wheel Ratchet Gear Hub 44 to the Expansion Gear 54 is a steel gear connected to the end of the Accelerator Shaft 52. Reduction Gear 56 is connected to the end of Coaxial Shaft Pairing Two Inner Shaft 38. The Safety Housing 58 is a transparent plastic membrane that surrounds the gearing protecting it from debris.

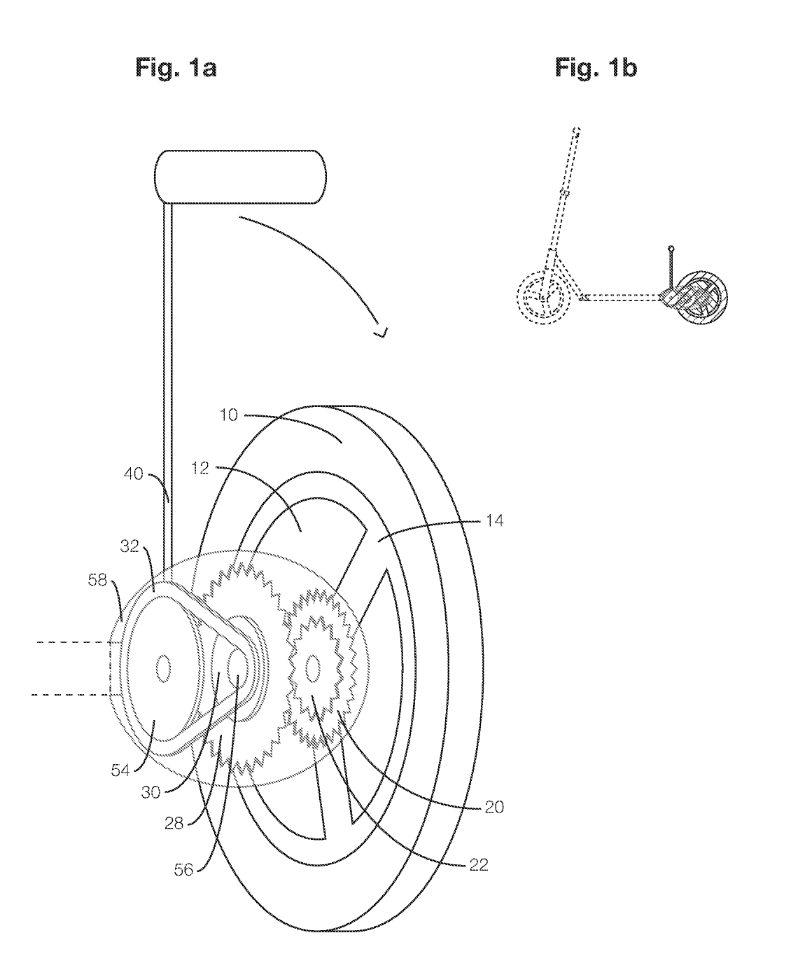

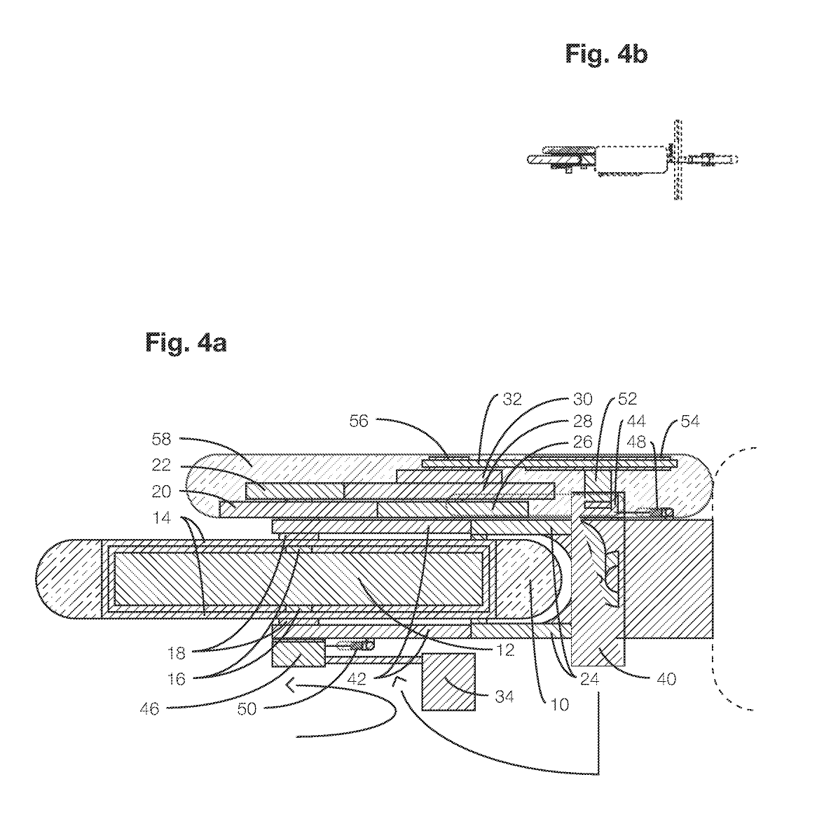

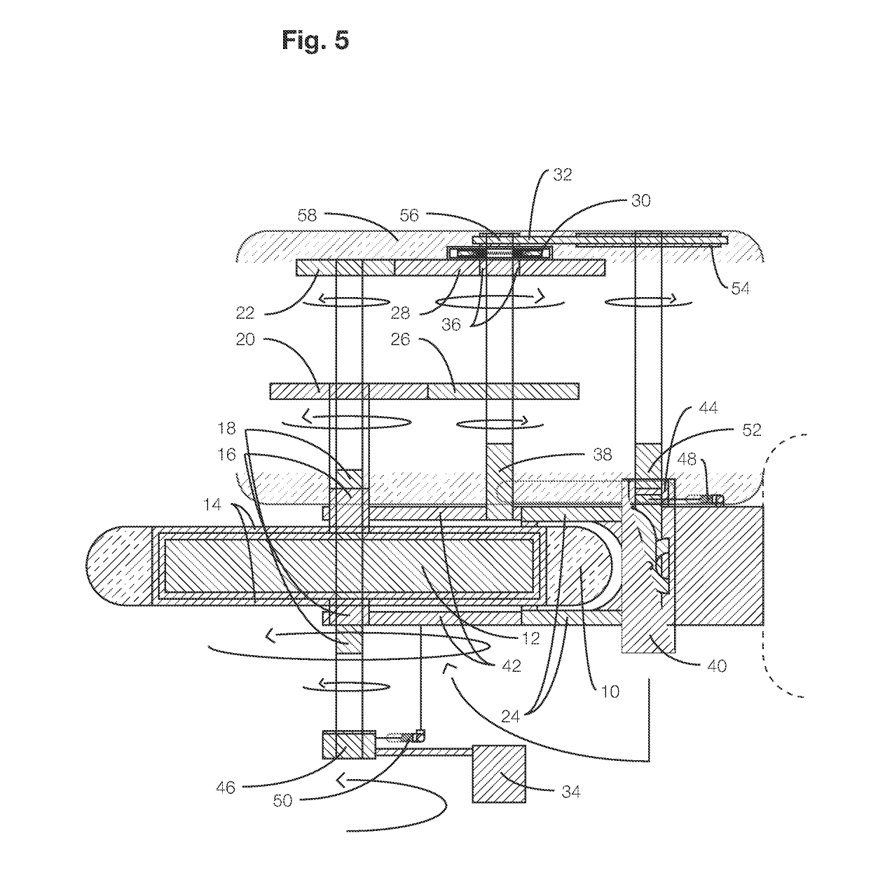

Referring jointly to FIG. 1a, 1b The Drive Wheel 10 concentrically contains the Flywheel 12 within the Spoke Structure 14. The Drive Wheel Hub Gear 20 is connected to 10 while the Flywheel Hub Gear 22 is connected to 12. The Flywheel Drive Gear 28 rotates 22 while The Drive Wheel Drive Gear 26 seen in FIGS. 4a, 5 rotates 20. Rider acceleration input from the accelerator pedal 40 is transferred from the Expansion Gear 54 via the Drive Chain 32 to the Reduction Gear 56 turning 26, 20 and 10 consistently while only above a once the vehicle is propelled to a speed between ten and fifteen miles per hour does the Centrifugal Clutch 30 pair that rider acceleration to the rotation of 28, 22 and 12.

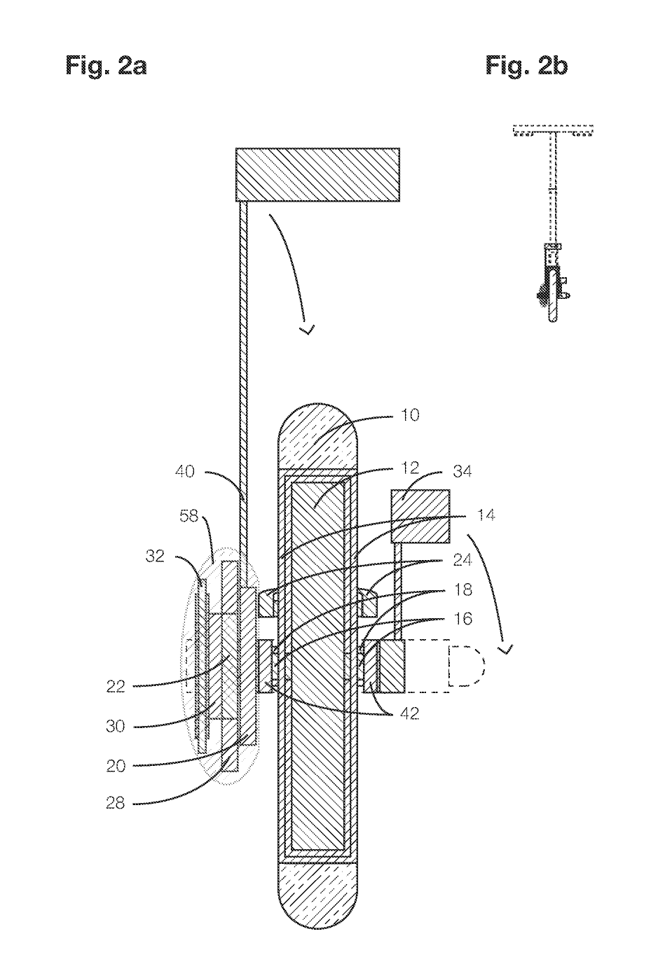

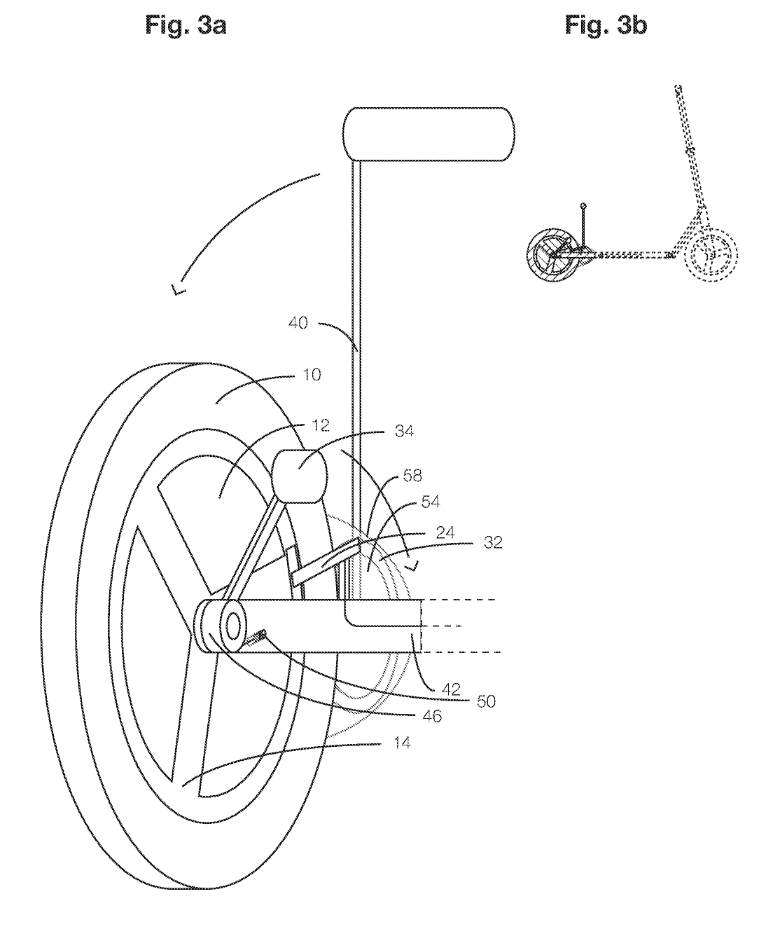

Referring jointly to FIG. 2a, 2b, 3a, 3b Located on the opposite side of the Drive Wheel Fork 42 from the Starter Pedal 34, the Accelerator Pedal 40 extends up through a slot in the Safety Housing 58 and over the Drive Wheel 10 and is retracted back upward by the Drive Wheel Tensioner 48 upon the down strokes of the rider's foot from a driving position so as to lever at its base the Drive Wheel Ratchet Gear Hub 44 to turn the Accelerator Shaft 52 that is connected at its end to the Expansion Gear 54 turning the Reduction Gear 56 with the Drive Chain 32. Alternately the Drive Chain 32 could be made longer as in the application of the invention to a bicycle thereby dispensing with the reciprocating type accelerator pedal used in the scooter application. The Reduction Gear 56 is connected to the outer end of the Coaxial Shaft Pairing Two Inner Shaft 36 with the Drive Wheel Drive Gear 26 connected at the inner end so as to rotate the Drive Wheel Hub Gear 20 which is attached to the Drive Wheel 10 through the Coaxial Shaft Pairing One Outer Shaft 18. The Coaxial Shaft Pairing One Outer Shaft 18 extends outward through a single side of the drive wheel fork to connect at its end to the Drive Wheel Hub Gear 20 while the Coaxial Shaft Pairing One Inner Shaft 16 extends further outward protruding from the opening on the end of the Coaxial Shaft Pairing One Outer Shaft 18 and Drive Wheel Hub Gear 20 to allow connection at its end to the Flywheel Hub Gear 22 outside of the air sealed space within the Drive Wheel 10 so as to set both 20, 22 parallel to one another as seen in FIG. 4a allowing 20, 22 to turn with 26, 28, 30 and 56. The Drive Wheel Hub Gear 20 and corresponding Drive Wheel Drive Gear 26 are of neutral ratio while The Flywheel Hub Gear 22 is of a reduced ratio to the Flywheel Drive Gear 28 so as to allow the Flywheel 12 to rotate faster than the Drive Wheel 10.

Referring jointly to FIGS. 4a, 4b, 5 The Drive Wheel Drive Gear 26 and Flywheel Drive Gear 28 are each arranged in parallel positions on the Coaxial Shaft Pairing Two Inner Shaft 38 Coaxial Shaft Pairing Two Outer Shaft 36 respectively. The Centrifugal Clutch 30 is positioned concentrically within the inner dimensions of the Flywheel Drive Gear 28 synchronizing the rotation of both parts as they form a single solid spinning mass in adherence to their joint function of coupling the rotation of the faster spinning Flywheel 12 to the Drive Wheel 10. The Coaxial Shaft Pairing One Inner Shaft 18 extends from a rotating position on a single side of the Drive Wheel Fork 42 and forward of the center axis of 10, 12, 14, 16, 20, & 22 at a length so as to allow equal center distance between 20, 22 and 26, 28 respectively. The rotation of the Coaxial Shaft Pairing Two Inner Shaft 38 remains connected to the rotation of the Drive Wheel Drive Gear 26 passing through Coaxial Shaft Pairing Two Outer Shaft 36 which is attached to the Flywheel Drive Gear 28 which contains the Centrifugal Clutch 30 concentrically within its dimensions allowing both the Flywheel Drive Gear 28 and Drive Wheel Drive Gear 26 to spin freely with their respective connected shafts and sets of corresponding hub gears until the Centrifugal Clutch 30 is activated when the vehicle reaches a speed between ten and fifteen miles per hour thereby synchronizing the rotation of all gears and shafts contained in the invention. The Brake 24 is mounted above the Drive Wheel Fork 42 and positioned forward of the Drive Wheel 10 on its longitudinal axis to make contact with the solid circumferential edge of Drive Wheel Spoke Structure 14 to slow the vehicle and thereby release the Centrifugal Clutch 30.

What is claimed is:

1. A vehicle drive system comprising:
A weighted flywheel positioned concentrically within an air sealed space inside a drive wheel allowing both the flywheel and drive wheel to rotate independently as they are attached respectively, to the inner and outer shafts of coaxial shaft pairing one of, coaxial shaft pairings one & two, of which in conjunction with their respective attached gears form two parallel sets of independent gearing allowing the flywheel to be coupled by a centrifugal clutch to the drive wheel once the vehicle is propelled to a speed between ten and fifteen miles per hour.
Extending outward from a single side of the drive wheel fork and contained within a safety housing, set in a linear arrangement of three, starting forward moving aft include reduction gearing and two coaxial shaft pairings.

2. The apparatus of claim 1 wherein coaxial shaft pair one contains:
a) an inner shaft attaching a flywheel to a reciprocating starter pedal on one side of the vehicle while protruding through the outboard end of (b) on the other side so as to be connected to a hub gear.
b) an outer shaft attaching a drive wheel to a hub gear on the same side that (a) protrudes through its outboard end.

3. The apparatus of claim 1 wherein coaxial shaft pair two contains:
a) an inner shaft extending from a rotating position on a single side of a drive wheel fork to convert rider acceleration input from reduction gearing to drive gearing for said drive wheel.
b) an outer shaft consisting of a drive gear for the flywheel containing concentrically within its dimensions a centrifugal clutch to pair the rotation of (a) and (b.)

4. A vehicle drive system comprising:
a first coaxial shaft pairing comprising an inner shaft and an outer shaft;
a drive wheel including an enclosed space;
a weighted flywheel positioned concentrically within the enclosed space; and
a centrifugal clutch,
wherein the flywheel is attached to the inner shaft of the coaxial shaft pairing, the drive wheel is attached to the outer shaft of the coaxial shaft pairing, and the flywheel and the drive wheel are capable of rotating independently, and wherein the flywheel is configured to be rotationally coupled to the drive wheel by a centrifugal clutch

5. The vehicle drive system of claim 4, further comprising a second coaxial shaft pairing, the second coaxial shaft pairing comprising:
an inner shaft extending from a rotating position on a first side of a drive wheel fork to convert rider acceleration input from a reduction gearing to a drive gearing for the drive wheel; and
an outer shaft including a drive gear for the flywheel,
wherein the centrifugal clutch is contained concentrically.

6. The vehicle drive system of claim 4,
wherein the inner shaft of the first coaxial shaft pairing attaches the flywheel to a reciprocating starter pedal on a first side of the vehicle while protruding through an outboard end of the outer shaft of the first coaxial shaft pairing, and wherein the outer shaft of the first coaxial shaft pairing attaches the drive wheel to a gear hub on the same side that the inner shaft protrudes through its outboard end.
